(19) United States
(12) Patent Application Publication
(10) Pub. No.: US 2006/0023391 A1
(43) Pub. Date: Feb. 2, 2006

(54) Ion generator

(75) Inventor: Hyeon Gi On, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/150,213

(22) Filed: Jun. 13, 2005

(30) Foreign Application Priority Data
Jul. 27, 2004 (KR) 2004-58862

(51) Int. Cl. H02H 1/00

(52) U.S. Cl. 361/212

(57) ABSTRACT

An ion generator for generating a sufficient quantity of ions in a short time and maintaining a level of the number of the ions harmless to the human body. The ion generator includes a first electrode and a second electrode. The first electrode generates cations in the air, and the second electrode, having a needle shape, is separated from the first electrode by a predetermined distance and has a predetermined height for generating electrons and anions. The cations generated from the first electrode and the electrons generated from the second electrode are reacted to produce hydrogen atoms, and the hydrogen atoms and the anions generated from the second electrode are reacted to destroy bacteria floating in the air.

### CROSS-REFERENCE TO RELATED APPLICATION

This application claims priority from Korean Patent Application No. 2004-58862, filed July 27, 2004, in the Korean Intellectual Property Office, the disclosure of which is incorporated herein by reference.

### BACKGROUND OF THE INVENTION

1. Field of the Invention

The present invention relates to a sterilizing apparatus, and more particularly to a sterilizing apparatus for eliminating bacteria in the air by generating cations and anions.

2. Description of the Related Art

Generally, an air purification apparatus comprises a filter installed in a housing for filtering out various impurities, an air blast fan for exhausting indoor air, which is introduced into the housing and passes through the filter, to the outside of the housing, and an anion generator for generating anions.

When the air blast fan of the air purification apparatus is operated, the indoor air is purified through the filter, and the purified air and the anions generated from the anion generator are exhausted to an indoor space. The sterilization using the filter and the anions of the above conventional air purification apparatus having the anion generator is limited. As a result, an ion generator, which generates both cations and anions for sterilization, has been developed. Japanese Patent Laid-open No. 2003-123940 discloses an ion generator for generating cations and anions.

The conventional ion generator applies an AC (alternating current) voltage to a discharge electrode and an induction electrode, alternately generates cations and anions, and supplies the cations and anions to an indoor space. Here, the cations are hydrogen ions (H⁺) and the anions are superoxide anions (O₂⁻). When the hydrogen ions (H⁺) and the superoxide anions (O₂⁻) are supplied to the indoor space, they form hydroxide radicals (OH) or hydrogen peroxide (H₂O₂) and the hydroxide radicals (OH) or hydrogen peroxide (H₂O₂) is attached to bacteria and oxidizes the bacteria, thereby removing the bacteria.

In case that the hydrogen ions (H⁺) and the superoxide anions (O₂⁻), which have negative health effects, generated from the above-described conventional ion generator are exhausted directly to the indoor space and inhaled by users, the hydrogen ions (H⁺) and the superoxide anions (O₂⁻) may damage a user's health. Since the ion generator alternately generates cations and anions, the cations and the anions are reacted with each other and are then destroyed before they can cause sterilization. Particularly, the ion generator, which generates cations and anions alternately, cannot generate a sufficient quantity of the cations and anions for sterilization in a short time.

### SUMMARY OF THE INVENTION

An aspect of the invention is to provide an ion generator, which generates a sufficient quantity of ions in a short time so as to maintain a level of generated ions which is harmless to the human body.

In accordance with one aspect, the present invention provides an ion generator for sterilization comprising: a first electrode for generating cations; and a second electrode, having a needle shape, separated from the first electrode by a predetermined distance and having a predetermined height for generating electrons and anions, wherein the cations generated from the first electrode and the electrons generated from the second electrode are reacted to produce hydrogen atoms, and the hydrogen atoms and the anions generated from the second electrode are reacted to destroy bacteria floating in the air.

In accordance with another aspect, the present invention provides an ion generator for sterilization comprising: a first electrode for generating hydrogen ions; and a second electrode, having a needle shape, separated from the first electrode by a distance of 25 mm˜50 mm and having a height of 5 mm˜25 mm for generating electrons and superoxide anions, wherein the hydrogen ions generated from the first electrode and the electrons generated from the second electrode are reacted to produce hydrogen atoms, and the hydrogen atoms and the superoxide anions generated from the second electrode are reacted to destroy bacteria floating in the air.

### BRIEF DESCRIPTION OF THE DRAWINGS

These and/or other aspects of the invention will become apparent and more readily appreciated from the following description of the exemplary embodiments, taken in conjunction with the accompanying drawings in which:

FIG. 1 is an exploded perspective view of an ion generator in accordance with an exemplary embodiment of the present invention;

FIG. 2 is a schematic view illustrating ions generated from the ion generator of FIG. 1;

FIGS. 3A, 3B, 3C, 3D and 3E are views illustrating a sterilizing process of the ion generator of FIG. 1;

FIG. 4 is a schematic view illustrating the relation between a ceramic plate and a needle-shaped electrode of the ion generator of FIG. 1; and

FIGS. 5A and 5B are graphs illustrating characteristics of the ion generator of FIG. 1.

### DETAILED DESCRIPTION OF EXEMPLARY EMBODIMENTS OF THE INVENTION

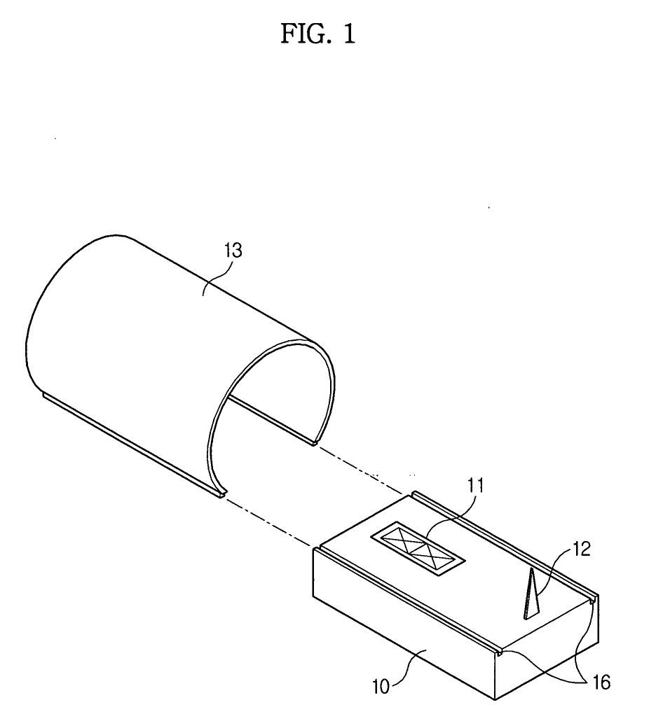

Reference will now be made in detail to the exemplary embodiment of the present invention, an example of which is illustrated in the accompanying drawings, wherein like reference numerals refer to like elements throughout. The exemplary embodiment is described below to explain the present invention by referring to FIGS. 1 to 5.

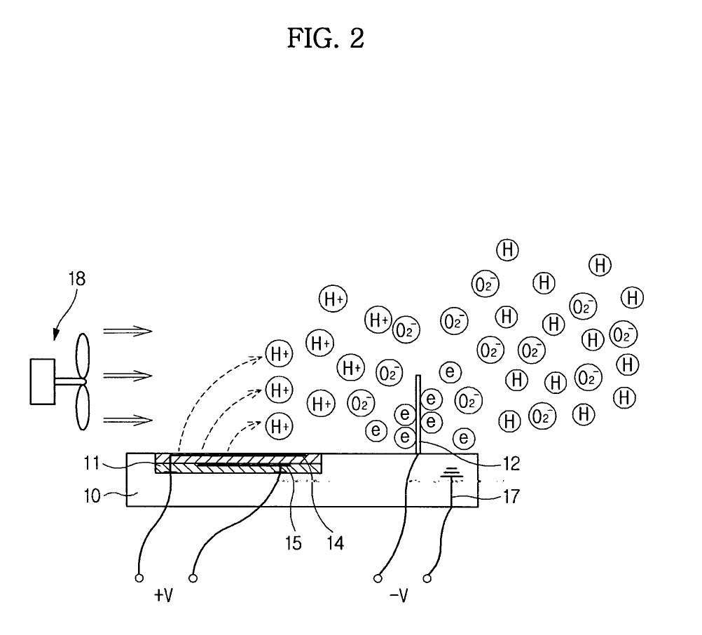

FIG. 1 is an exploded perspective view of an ion generator in accordance with an exemplary embodiment of the present invention. FIG. 2 is a schematic view illustrating ions generated from the ion generator of FIG. 1.

As shown in FIGS. 1 and 2, the ion generator comprises a ceramic plate 11 mounted on the upper surface of a supporter 10, a needle-shaped electrode 12 separated from the ceramic plate 1I by a predetermined distance, and a cover 13 for restricting the diffusion range of ions, generated from the ceramic plate 11 and the needle-shaped electrode 12, within a designated space.

A depression for receiving the ceramic plate 11 is formed in an upper surface of the supporter 10, and the ceramic plate 11 is inserted into the depression. The ceramic plate 11 is a unit for generating cations, and includes a discharge electrode 14 placed on an upper part of the inside thereof, and an induction electrode 15 placed on a central part of the inside thereof. Other parts of the ceramic plate 11 except for the discharge electrode 14 and the induction electrode 15 are made of ceramic, thereby producing a protection layer.

A high voltage having positive polarity (+) (preferably, approximately 3.9 kV˜4.3 kV, but it is possible to apply more or less than this voltage range) is applied to the part of the ceramic plate 11 between the discharge electrode 14 and the induction electrode 15. When the high voltage having positive polarity (+) is applied the part of the ceramic plate 11 between the discharge electrode 14 and the induction electrode 15, moisture (H₂O) in the air is ionized by plasma discharge of the ceramic plate 11, thereby producing hydrogen ions (H⁺).

A high voltage having negative polarity (−) (approximately 3.2 kV˜3.6 kV) is applied to the part of the supporter 10 between the needle-shaped electrode 12 and a ground electrode 17. When the high voltage having negative polarity (−) is applied to the needle-shaped electrode 12, cations are accumulated around the needle-shaped electrode 12 by plasma discharge and a large quantity of electrons from the needle-shaped electrode 12 are exhausted to the air. The large quantity of electrons exhausted to the air are unstable and are captured by oxygen molecules (O₂), thus forming superoxide anions (O₂⁻). That is, when the high voltage having negative polarity (−) is applied to the needle-shaped electrode 12, the needle-shaped electrode 12 generates the electrons and the superoxide anions (O₂⁻).

When electrons are generated from the needle-shaped electrode 12, the electrons react with hydrogen ions, which are generated from the ceramic plate 11 and pass through the circumference of the needle-shaped electrode 12, thereby producing hydrogen atoms (H, or active hydrogen). Here, a blowing device 18, serving to easily bond the hydrogen ions generated from the ceramic plate 11 to the electrons generated from the needle-shaped electrode 12, is installed at one side of the ion generator. The blowing device 18 is operated, thereby forcibly transmitting the hydrogen ions to the needle-shaped electrode 12.

As described above, the hydrogen ions generated from the ceramic plate 11 react with the electrons generated from the needle-shaped electrons 12, and produce hydrogen atoms (H). Accordingly, substances, which are finally exhausted from the ion generator of the present invention, are hydrogen atoms (H) and superoxide anions (O₂⁻).

The cover 13 has a tunnel shape, and is attached to and detached from the supporter 10 by sliding both sides of the lower portion of the cover 13 along a cover rail 16 formed in both sides of the upper surface of the supporter 10 in a longitudinal direction. When the ion generator generates hydrogen ions and the blowing device 18 at one side of the cover 13 blows air under the condition that the cover 13 is attached to the supporter 10, the hydrogen ions in the cover 13 are transmitted toward the needle-shaped electrode 12, react with the electrons generated from the needle-shaped electrode 12, and produce hydrogen atoms (H), and the produced hydrogen atoms (H) are exhausted to the other side of the cover 13. Further, the superoxide anions (O₂⁻) generated from the needle-shaped electrode 12 are exhausted together with the hydrogen atoms (H) to the other side of the cover 13 by the blown air.

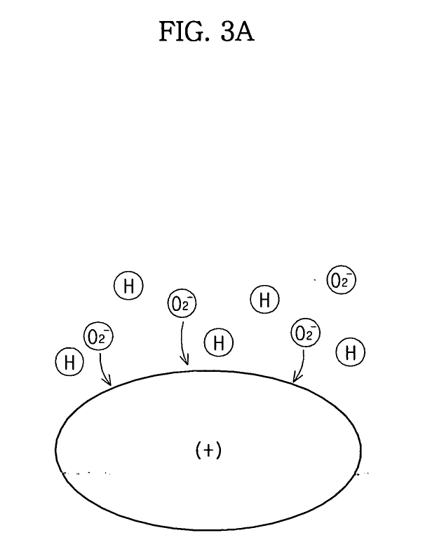

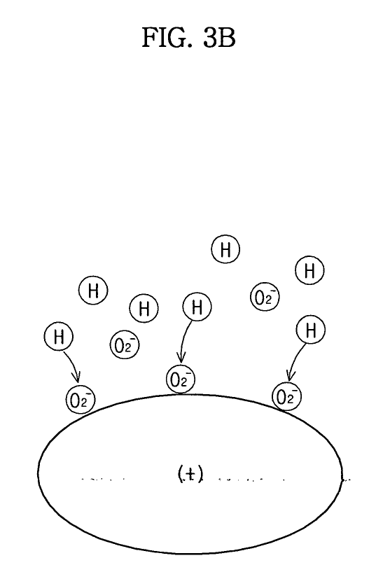

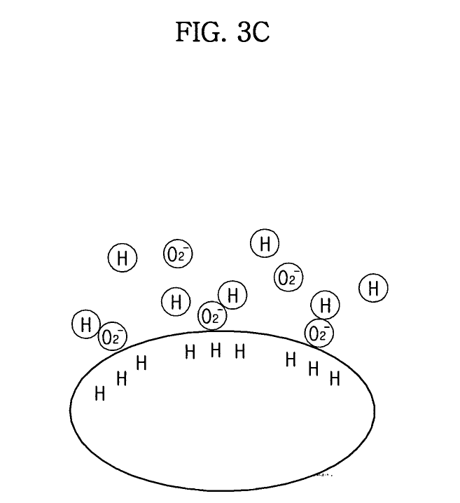

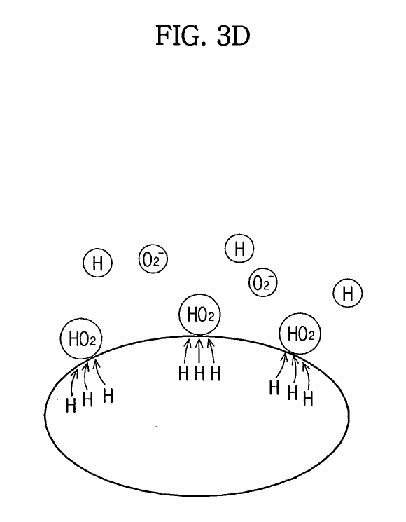

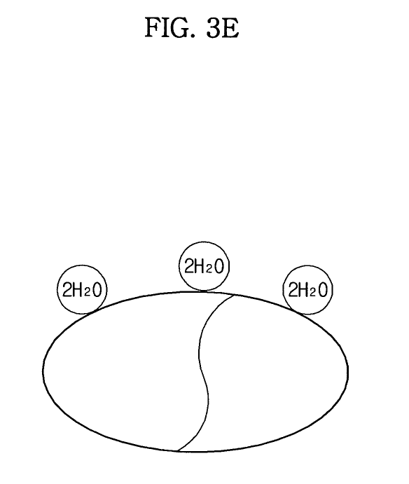

FIGS. 3A to 3E are views illustrating a sterilizing process of the ion generator of FIG. 1. As shown in FIG. 3A, when the ion generator exhausts hydrogen atoms (H) and superoxide anions (O₂⁻) to the air, the superoxide anions (O₂⁻) having a negative polarity (−) are attached onto the surfaces of bacteria floating in the air by the static electricity (having a positive polarity (+)) of the bacteria. Then, as shown in FIGS. 3B and 3C, the hydrogen atoms (H) are attached to the superoxide anions (O₂⁻) absorbed onto the surfaces of the bacteria.

When the hydrogen atoms (H) and the superoxide anions (O₂⁻) are attached to the surfaces of the bacteria, they react as shown in FIGS. 3D and 3E by Equations 1 and 2 below.
H+O₂⁻→HO₂ (hydroperoxy radical)+e+static electricity of bacteria Equation 1
HO₂+3H (hydrogen atom of protein constituting cell membrane of bacteria)→2H₂O Equation 2

That is, the hydrogen atoms (H) and the superoxide anions (O₂⁻), which contact each other, produce hydroperoxy radicals (HO₂), and electrons (e) of the superoxide anions (O₂⁻) offset the static electricity of the bacteria. Further, one hydroperoxy radical (HO₂) captures three hydrogen atoms (H) out of proteins constituting cell membranes of the bacteria, and produce two molecules of water. Accordingly, the protein modules of the cell membranes lose their hydrogen atoms (H), and are destroyed, thus causing the cell membranes of the bacteria to be destroyed. As a result, the bacteria are killed.

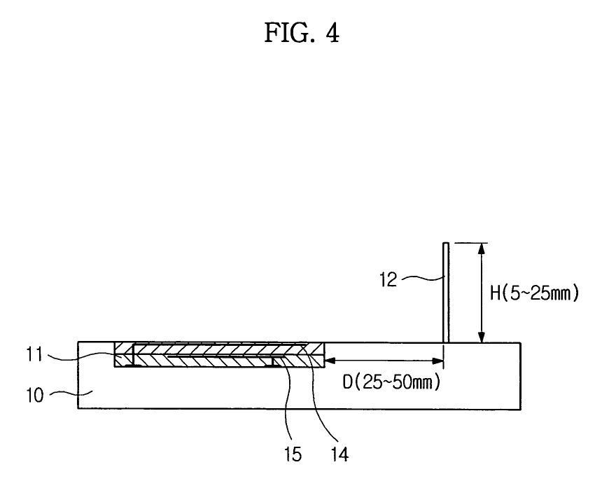

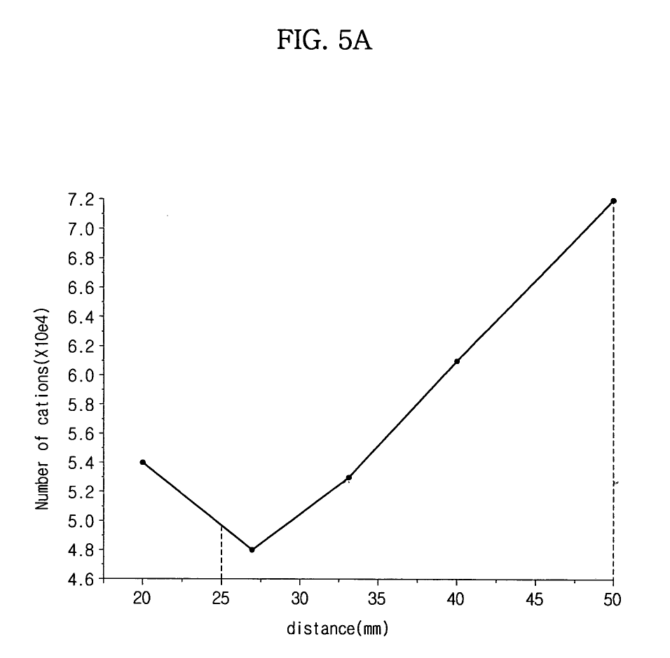

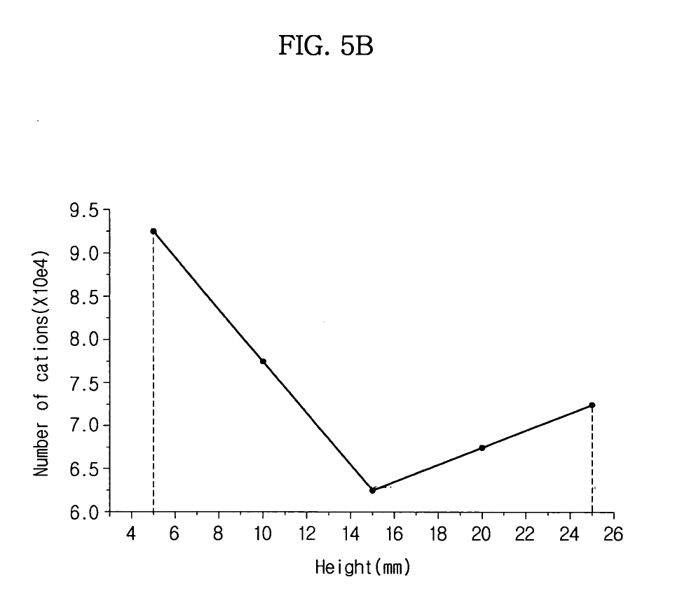

FIG. 4 is a schematic view illustrating the relation between the ceramic plate and the needle-shaped electrode of the ion generator of FIG. 1, and FIGS. 5A and 5B are graphs illustrating characteristics of the ion generator of FIG. 1. As shown in FIGS. 4, 5A and 5B, the needle-shaped electrode 12 is separated from the ceramic plate 11 by a predetermined distance. The number of the hydrogen ions generated from the ceramic plate 11, which are changed into the hydrogen atoms (H), varies according to the separation distance between the needle-shaped electrode 12 and the ceramic plate 11 and the height of the needle-shaped electrode 12. Accordingly, the separation distance between the needle-shaped electrode 12 and the ceramic plate 11 is adjusted by the size of the ceramic plate 11 and the height of the needle-shaped electrode 12. That is, as shown in FIGS. 5A and 5B, in case that the separation distance between the needle-shaped electrode 12 and the ceramic plate 11 is approximately 25 mm˜50 mm and the height of the needle-shaped electrode 12 is approximately 5 mm˜25 mm, the numbers of cations and anions, which react with each other, are maximized within the range harmless to the human body, thereby maximizing the number of active hydrogens.

As apparent from the above description, the present invention provides an ion generator using, instead of hydrogen ions harmful to the human body, hydrogen atoms (H) for sterilization, in which the hydrogen atoms (H) react with superoxide anions (O₂⁻), i.e., a kind of active oxygen, and are neutralized, thereby having sterilization effects and preventing a user from being exposed to the hydrogen ions or the superoxide anions (O₂⁻) being harmful to the human body.

Further, the ion generator according to the exemplary embodiment of the present invention comprises a cation generating unit and an anion generating unit, which are separated from each other so that the cation and anion generating units alternately generate cations and anions, thereby preventing the number of the cations and anions used for sterilization from being reduced due to the extermination of the cations and anions by their reaction.

Moreover, the ion generator according to the exemplary embodiment of the present invention, which comprises the separated cation and anion generating units, generates a sufficient quantity of the cations and anions, thereby improving sterilization effects.

Although an exemplary embodiment of the invention has been shown and described, it would be appreciated by those skilled in the art that changes may be made in the exemplary embodiment without departing from the principles and spirit of the invention, the scope of which is defined in the claims and their equivalents.

What is claimed is:

1. An ion generator for sterilization comprising:
a first electrode which generates cations; and
a second electrode which generates electrons and anions, the second electrode having a needle shape and being separated from the first electrode by a predetermined distance,
wherein the cations generated by the first electrode and the electrons generated by the second electrode are reacted to produce hydrogen atoms, and the hydrogen atoms and the anions generated by the second electrode are reacted to destroy bacteria floating in air.

2. The ion generator according to claim 1, wherein the predetermined distance separating the first electrode and the second electrode is in the range of 25 mm to 50 mm.

3. The ion generator according to claim 1, wherein a height of the second electrode is in the range of 5 mm to 25 mm.

4. The ion generator according to claim 1, wherein the first electrode comprises a discharge electrode and an induction electrode separated from the discharge electrode; and a high voltage having a positive polarity is applied to an area between the discharge electrode and the induction electrode.

5. The ion generator according to claim 1, wherein a high voltage having a negative polarity is applied to the second electrode.

6. An ion generator for sterilization comprising:
a first electrode which generates hydrogen ions; and
a second electrode which generates electrons and superoxide anions, the second electrode having a needle shape and a height of 5 mm to 25 mm and being separated from the first electrode by a distance of 25 mm to 50 mm,
wherein the hydrogen ions generated by the first electrode and the electrons generated by the second electrode are reacted to produce hydrogen atoms, and the hydrogen atoms and the superoxide anions generated by the second electrode are reacted to destroy bacteria floating in the air.
